(19) United States
(12) Patent Application Publication
(10) Pub. No.: US 2017/0059075 A1
(43) Pub. Date: Mar. 2, 2017

(54) PIPE COUPLING STRUCTURE

(71) Applicant: CKD CORPORATION, Komaki-shi (JP)

(72) Inventor: Satoshi UENO, Tokyo-to (JP)

(73) Assignee: CKD CORPORATION, Komaki-shi (JP)

(21) Appl. No.: 15/219,914

(22) Filed: Jul. 26, 2016

(30) Foreign Application Priority Data
Aug. 31, 2015 (JP) 2015-169930

(51) Int. Cl. F16L 55/07; A01G 25/16; F16K 31/06

(52) U.S. Cl. CPC F16L 55/07; F16K 31/06; A01G 25/165

(57) ABSTRACT

A pipe coupling structure includes an electromagnetic valve and a passage block having an upper surface mounted with the electromagnetic valve and opposite side surfaces formed with an inlet port and an outlet port. The inlet port is connected to a PCV pipe through an inlet pipe joint, and the outlet port is connected to a PCV pipe through an outlet pipe joint. At least one of the inlet pipe joint and the outlet pipe joint is a union joint. The union joint includes a hollow cylindrical union end making contact with a first surface formed with the inlet port or a second surface formed with the outlet port and a hollow cylindrical union nut configured to connect the inlet port or the outlet port to the union end.

### CROSS-REFERENCE TO RELATED APPLICATIONS

This application is based upon and claims the benefit of priority from the prior Japanese Patent Application No. 2015-169930, filed Aug. 31, 2015, the entire contents of which are incorporated herein by reference.

### BACKGROUND

Technical Field

The present description relates to a pipe coupling or fitting structure including an electromagnetic valve and a passage block having an upper surface on which the electromagnetic valve is mounted and opposite side surfaces in which an inlet port and an outlet port individually formed, in which the inlet port is connected to an inlet pipe through an inlet pipe joint and the outlet port is connected to an outlet pipe through an outlet pipe joint.

Related Art

Heretofore, sprinkler systems have been used for irrigating and sprinkling for horticulture under structure, sprinkling in parks or urban green areas, and others. In particular, an agricultural sprinkler uses a resin passage block as a pipe for fluid flow in consideration of fertilizer, agrichemicals, and others containing copper ions or the like. This type of sprinkler is attached with a fluid control device for controlling fluid. As the fluid control device there is mainly used an electromagnetic valve.

In the conventional agricultural sprinkler, a pipe coupling structure 100 shown in FIGS. 6 and 7 has been used. FIG. 6 is a sectional view of the conventional pipe coupling structure 100 and FIG. 7 is an exploded view of the pipe coupling structure 100.

As shown in FIG. 6, the pipe coupling structure 100 includes an actuator section 101 and a pipe section 102. The actuator section 101 includes an electromagnetic valve 103 and a flow control mechanism 104. Under a lower surface of the actuator section 101, a passage block 105 is placed. Opposite side surfaces of the passage block 105 are individually formed with an inlet port 106 and an outlet port 107. The inlet port 106 is connected to a valve socket 109 to which a polyvinyl chloride (PCV) pipe 108 is adhered. An aluminum ring 112 is fitted on the inlet port 106 for reinforcement of connection. Similarly, the outlet port 107 is connected to a valve socket 111 to which a PCV pipe 110 is adhered. An aluminum ring 113 is fitted on the outlet port 107.

As shown in FIG. 7, in the pipe section 102, when the inlet port 106 and the valve socket 109 are to be connected, the valve socket 109 is screw-connected to the inlet port 106 through taper male threads 109a formed on an outer periphery of an end part of the valve socket 109 and taper female threads 106a formed on an inner periphery of an end part of the inlet port 106. Similarly, the outlet port 107 and the valve socket 111 are screw-connected to each other through taper male threads 111a formed on an outer periphery of an end part of the valve socket 111 and taper female threads 107a formed on an inner periphery of an end part of the outlet port 107. For the screw connection, a seal tape is used for sealing. Thereafter, the PCV pipes 108 and 110 are respectively connected to the valve sockets 109 and 111.

The pipe coupling structure in Patent Document 1 discloses a union joint including a union end and a union nut.

### RELATED ART DOCUMENTS

### Patent Documents

Patent Document 1: Japanese unexamined patent application publication No. 2010-78070

### SUMMARY

### Technical Problems

However, the conventional pipe coupling structure 100 may cause the following problems. In the pipe coupling structure 100, specifically, the passage block 105 is made of resin and thus, if the taper male treads 109a are screwed too tightly into the taper male threads 106a, the passage block 105 may be broken. Even when the rings 112 and 113 for reinforcement are respectively mounted around the inlet port 106 and the outlet port 107 in order to avoid such breakage of the passage block 105, the inlet port 106 and the outlet port 107 may still be broken.

In the pipe coupling structure 100, if the PCV pipes 108 and 110 are inserted in advance in the corresponding valve sockets 109 and 111, these valve sockets 109 and 111 attached with the PCV pipes 108 and 110 could not be readily connected to the passage block 105. Specifically, the valve sockets 109 and 111 have to be rotated together with the PCV pipes 108 and 110 to be threaded into the inlet port 106 and the outlet port 107. This rotation could not be easily conducted. Accordingly, it is necessary to separately bring the valve sockets 109 and 111 and the PCV pipes 108 and 110 from a factory to an actual work site and then screw-connect the passage block 105 with the valve sockets 109 and 111 and further adhere the PCV pipes 108 and 110 to the valve sockets 109 and 111. However, since the PCV pipes 108 and 110 are long and hard to handle, when the passage block 105 is screw-connected to the valve sockets 109 and 111 and thereafter the PCV pipes 108 and 110 are adhered, the PCV pipes 108 and 110 are hard to insert deeply into the corresponding valve sockets 109 and 111 as shown in FIG. 6. This results in variation in length between connected pipes. Thus, the pipes have to be adjusted in length at the actual work site. This deteriorates workability.

Moreover, if the pipe coupling structure 100 is applied to connect PCV pipes having different diameters from the diameters of previously connected pipes, it is necessary to change not only the diameter of the valve socket but also the diameters of the inlet port and the outlet port. Accordingly, valve sockets having different diameters and corresponding passage blocks are demanded. Consequently, it is necessary for connection of a PCV pipe having different diameter from a previous one to further prepare a valve socket and a passage block corresponding to the target PCV pipe. This leads to excess stocks of passage blocks, union ends, and others, and cost increase.

The present disclosure has been made to solve the aforementioned problems and has a purpose to provide a pipe coupling structure capable of achieving pipe connection with good workability without damaging a resin passage block and at reduced cost.

### Means of Solving the Problems

(1) To achieve the above purpose, one aspect of the present disclosure provide a pipe coupling structure comprising: an electromagnetic valve and a passage block having an upper surface on which the electromagnetic valve is mounted and opposite side surfaces in which an inlet port and an outlet port are individually formed, the inlet port being connected to an inlet pipe through an inlet pipe joint and the outlet port being connected to an outlet pipe through an outlet pipe joint, wherein at least one of the inlet pipe joint and the outlet pipe joint is a union joint, the opposite side surfaces are a first surface and a second surface, the first surface being formed with the inlet port and the second surface being formed with the outlet port, and the union joint includes: a union end having a hollow cylindrical shape and being in contact with one of the first surface and the second surface; and a union nut having a hollow cylindrical shape and being configured to connect one of the inlet port and the outlet port with the union end.

(2) The pipe coupling structure described in (1) may be configured such that at least one of the inlet pipe and the outlet pipe is placed in an inner periphery of the union end, and the union end is formed with a protruding portion protruding radially inward at an end of the inner periphery on a side where the union end makes contact with one of the first surface and the second surface, the protruding portion making contact with the at least one of the inlet pipe and the outlet pipe, and the at least one of the inlet pipe and the outlet pipe is adhered to the union end while the at least one of the inlet pipe and the outlet pipe is placed in contact with the protruding portion.

(3) The pipe coupling structure described in (2) may be configured such that the union end is selected from a plurality of union ends having different inner diameters from each other according to an outer diameter of the at least one of the inlet pipe and the outlet pipe to be connected to the passage block.

(4) The pipe coupling structure described in any one of (1) to (3) may be configured to further comprise an elastic member placed between one of the first surface and the second surface and an end face of the union end.

(5) The pipe coupling structure described in any one of (1) to (4) may be configured such that the passage block includes a protruding part protruding from a lower surface of the passage block.

### Advantageous Effects

The pipe coupling structure in one aspect of the present disclosure provides the following advantageous effects. Specifically, with the aforementioned configuration (1), the union end can be connected to the passage block through the union nut while the union end are in contact with the first surface or the second surface of the passage block. Accordingly, the inlet pipe joint or the outlet pipe joint does not need to be screwed into the passage block and thus the passage block is less likely to be broken. Further, the inlet pipe or the outlet pipe can be adhered in advance to the union end and then connected to the passage block. This causes no variation or difference in length between the connected pipes and thus needs no work for adjustment of the pipe lengths at an actual work site. This leads to enhanced workability for pipe connection.

With the aforementioned configuration (2), the union end can be connected to the passage block through the union nut while the union end is in contact with the first surface or the second surface of the passage block. Accordingly, the inlet pipe joint or the outlet pipe joint does not need to be screwed into the passage block and thus the passage block is less likely to be broken. Further, the union end having adhered thereto the at least one of the inlet pipe and the outlet pipe remaining contacted with the protruding portion can be connected to the passage block, so that no variation in length occurs between the connected pipes. This can achieve enhanced workability.

With the aforementioned configuration (3), for connection of the inlet pipe or the outlet pipe different in outer diameter from a previously used one, the union end has only to be changed in inner diameter while having the same outer diameter from a previous one. Consequently, it is necessary to stock only a union end or union ends having different inner diameters adaptable to different inlet or outlet pipes. This can eliminate the need to stock redundant passage blocks, union ends, and others, and can achieve cost reduction.

With the aforementioned configuration (4), there is no need to apply a seal tape, so that enhanced workability for pipe connection is achieved.

With the aforementioned configuration (5), the protruding part supports the pipe coupling structure, so that pipe arrangement can be facilitated with enhanced workability.

### BRIEF DESCRIPTION OF THE DRAWINGS

FIG. 1 is a sectional view of a pipe coupling structure in a valve-closed state;

FIG. 2 is an enlarged view of an area A in FIG. 1, showing a valve-open state;

FIG. 3 is an exploded view of the pipe coupling structure;

FIG. 4 is an assembling view of the pipe coupling structure;

FIG. 5 is a sectional view of the pipe coupling structure in arranging PCV pipes having different diameters from those in FIG. 1;

FIG. 6 is a sectional view of a pipe coupling structure in a related art; and

FIG. 7 is an exploded view of the pipe coupling structure in the related art.

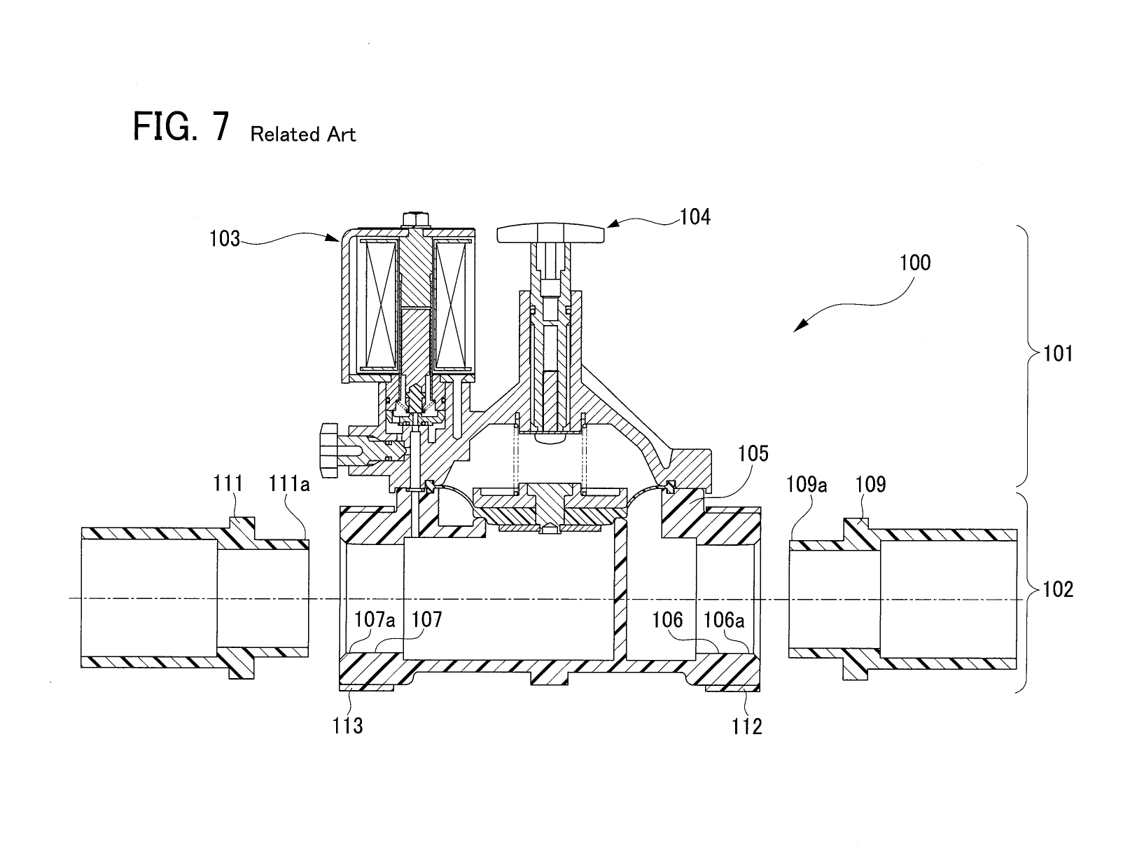

### DESCRIPTION OF EMBODIMENTS

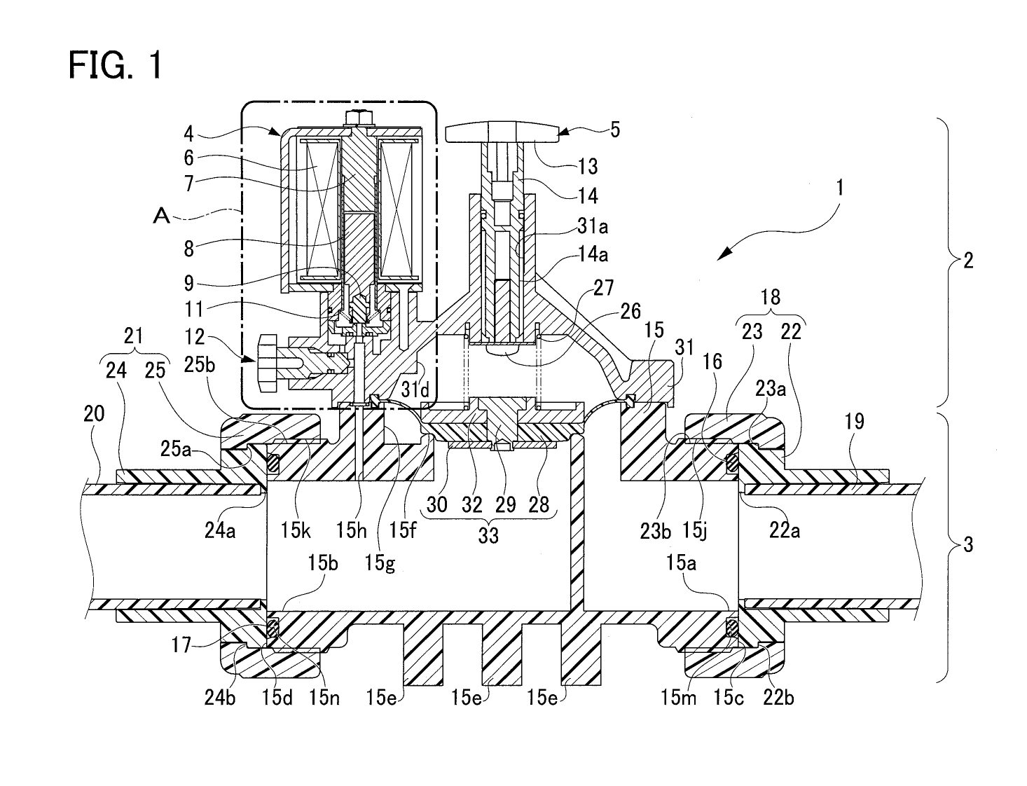

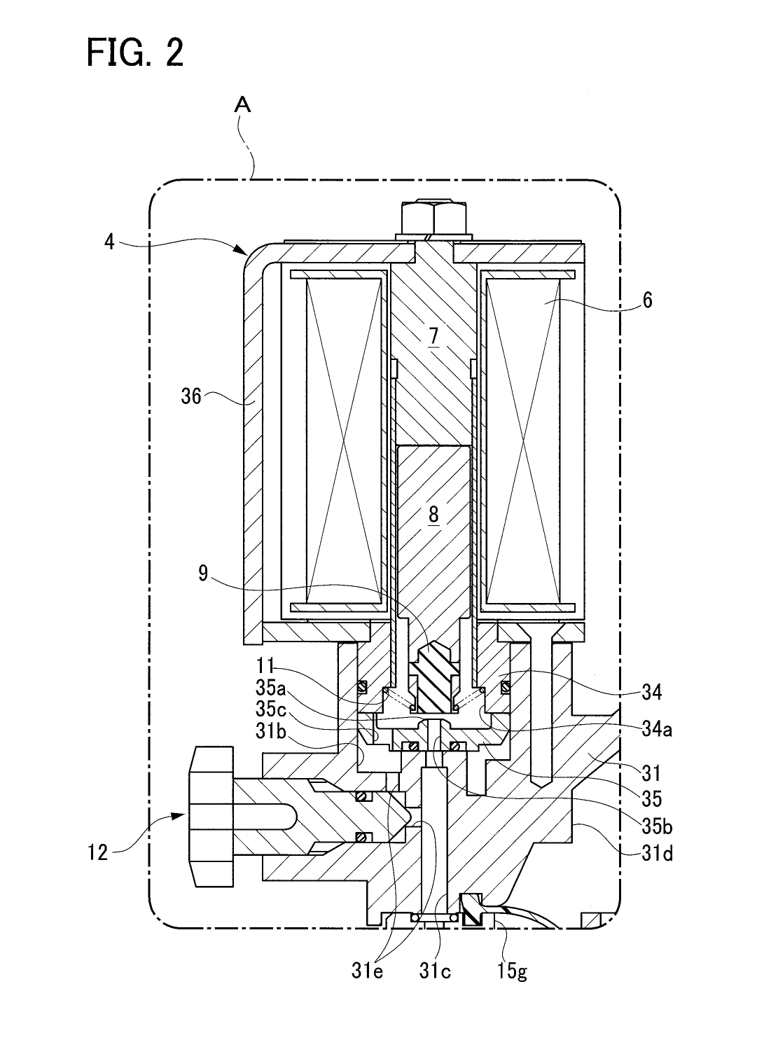

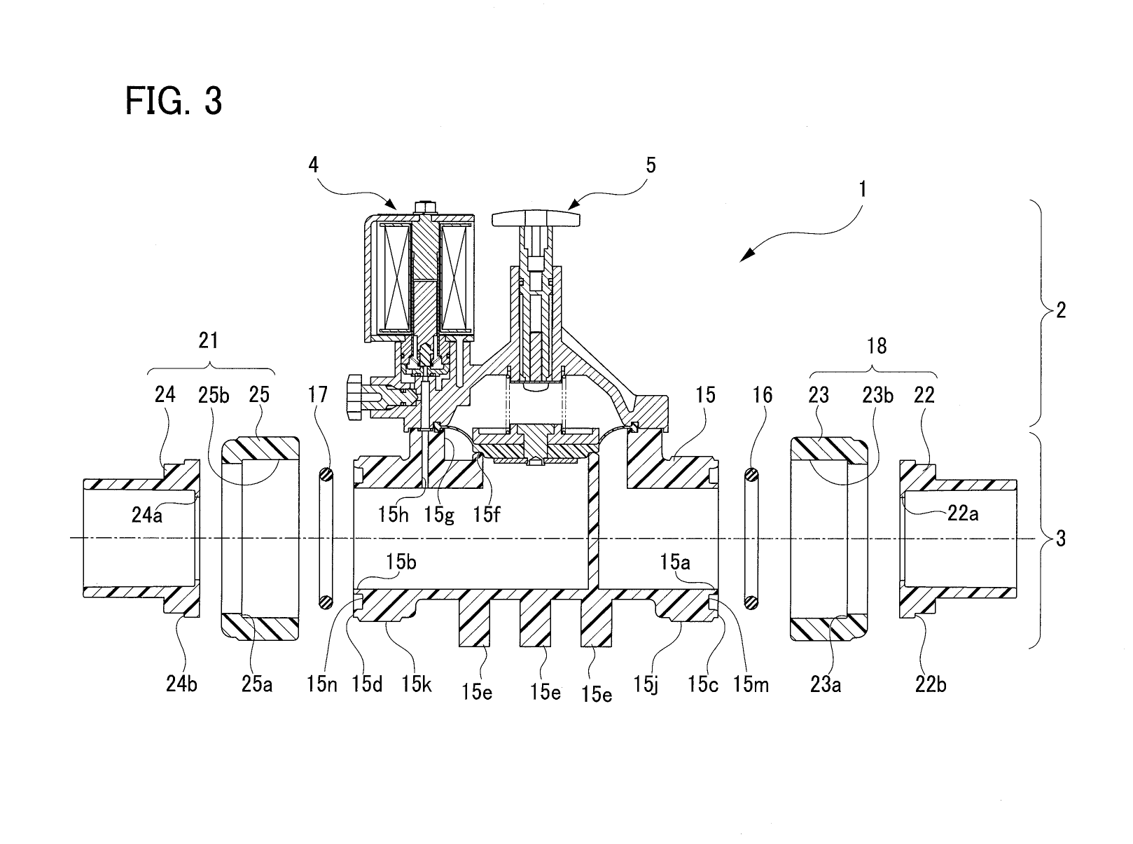

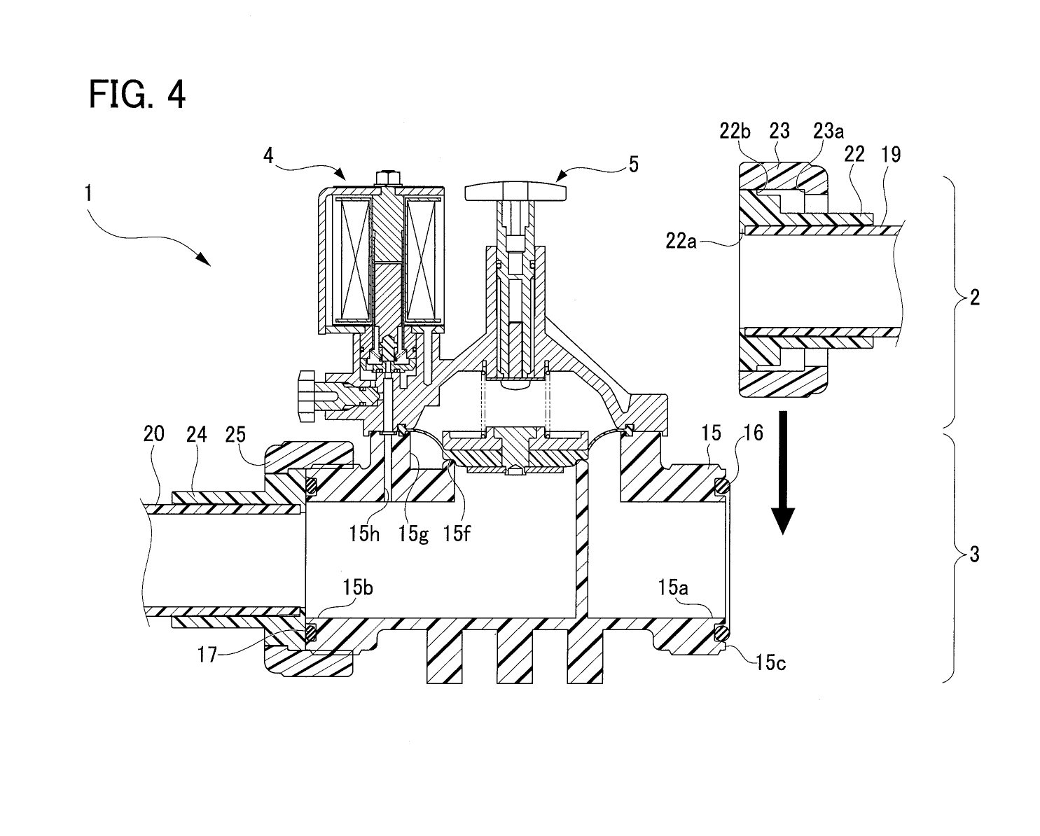

A detailed description of a pipe coupling structure which is one of typical embodiments of this disclosure will now be given referring to the accompanying drawings. FIG. 1 is a sectional view of a pipe coupling structure 1 in a valve-closed state in the present embodiment. FIG. 2 is an enlarged view of an area A in FIG. 1, showing a valve open state. FIG. 3 is an exploded view of the pipe coupling structure 1. FIG. 4 is an assembling view of the pipe coupling structure 1.

(Configuration of Pipe Coupling Structure)

The pipe coupling structure 1 includes an actuator section 2 and a pipe section 3 as shown in FIG. 1. The configuration of the actuator section 2 will be described first. This actuator section 2 mainly includes a body 31 provided with an electromagnetic valve 4, a flow control mechanism 5, and a manual valve 12.

The configuration of the electromagnetic valve 4 will be first described referring to FIGS. 1 and 2. This electromagnetic valve 4 is placed on a left side of the body 31 in FIG. 1. The electromagnetic valve 4 includes a hollow coil 6 placed in a cover 36. In a central hole of the coil 6, a fixed core 7 is fixedly provided on an upper side and movable core 8 is held on a lower side to be movable in a linear direction. At the bottom of the movable core 8, a pilot valve element 9 made of rubber is provided.

As shown in FIG. 2, the electromagnetic valve 4 is fixed to the body 31 through a securing member 34. Between this securing member 34 and the body 31, a valve socket member 35 is placed. A passage 31b is formed between the body 31 and the valve seat member 35. Further, a passage 34a is formed between the securing member 34 and the valve seat member 35. The valve seat member 35 is formed on its left side in FIG. 2 with a passage 35c and formed at its center with a valve hole 35b. The valve seat member 35 is further formed with a valve seat 35a which the pilot valve element 9 comes into or out of contact with. The movable core 8 is formed, at its lower end, with a flange receiving one end of an urging spring 11. The other end of the urging spring 11 abuts on the securing member 34. Thus, the urging spring 11 urges the pilot valve element 9 in a direction to come into contact with the valve seat 35a.

In FIG. 1, the coil 6 is not energized, so that the pilot valve element 9 is held in contact with the valve seat 35a by the urging force of the urging spring 11, thereby interrupting communication between the passage 34a and the valve hole 35b. In contrast, when the coil 6 is energized, causing the fixed core 7 to attract the movable core 8 upward, the pilot valve element 9 moves apart from the valve seat 35a, thus providing communication between the passage 34a and the valve hole 35b as shown in FIG. 2.

The body 31 is formed with a passage 31c communicated with the valve hole 35b. Further, a passage 31e is formed to connect the passage 31c with the passage 31b. In this passage 31e, i.e., between the passages 31c and 31b, a manual valve 12 is placed. The passage 31c is communicated with a passage 15h of the passage block 15. This passage 15h is communicated with an outlet port 15b which will be described later.

The flow control mechanism 5 is described below referring to FIG. 1. This flow control mechanism 5 is placed on a right side of the body 31 in FIG. 1. The flow control mechanism 5 includes a handle knob 13, a rod 14, and a valve element unit 33. The rod 14 is formed on its outer periphery with male threads 14a. The body 31 is formed with a through hole through which the rod 14 extends. This through hole is formed with female threads 31a engageable with the male threads 14a of the rod 14. The rod 14 is attached with the handle knob 13 at one end and a contact part 26 at the other end. With respect to this contact part 26, a fixing part 29 mentioned later will come into contact.

The valve element unit 33 is placed between the body 31 and the passage block 15. An inner passage 31d is formed between the body 31 and the valve element unit 33. An inner passage 15g is formed between the passage block 15 and the valve element unit 33. These inner passages 31d and 15g are communicated with each other through a pilot filter not illustrated. The inner passage 31d is further communicated with a passage 31b shown in FIG. 2 through a passage not illustrated. The valve element unit 33 is provided with a diaphragm 28, a lower plate 30, and an upper plate 32, which are integrally connected through the fixing part 29. An outer peripheral edge of the diaphragm 28 is sandwiched between the body 31 and the passage block 15. The diaphragm 28 is moved into or out of contact with a valve seat 15f annularly located at the center of the passage block 15. One end of an urging spring 27 contacts an upper surface of the upper plate 32, while the other end of the urging spring 27 contacts a lower surface of the body 31. Thus, the urging spring 27 urges the valve element unit 33 in a direction to come into contact with the valve seat 15f.

The pipe section 3 in the present embodiment will be described below referring to FIGS. 1 and 3. The passage block 15 has opposite side surfaces, namely, a first surface 15c and a second surface 15d. On an upper surface of the passage block 15 in FIG. 1, the electromagnetic valve 4 and the flow control mechanism 5 are mounted. The passage block 15 is formed with three protruding parts 15e protruding downward from a lower surface of the passage block 15. The first surface 15c is formed with an inlet port 15a communicated with the inner passage 15g. The second surface 15d is formed with an outlet port 15b. The inlet port 15a is connected to an inlet PCV pipe 19 which is one example of an inlet pipe by use of an inlet pipe joint 18.

This inlet pipe joint 18 will be explained below. As shown in FIGS. 1 and 3, the inlet pipe joint 18 is a union joint and includes a union end 22 and a union nut 23. The union end 22 has a hollow cylindrical shape whose end face is in contact with the first surface 15c. In the inner periphery (a hollow part) of the union end 22, the PCV pipe 19 is disposed. The union end 22 is formed with a protruding portion 22a radially inwardly protruding in an annular flange shape at one end in an axial direction, i.e., at an end of the inner periphery on a side where the union end 22 makes contact with the first surface 15c, so that the PCV pipe 19 makes contact with the protruding portion 22a. Thus, the PCV pipe 19 inserted in the union end 22 is adhered to the union end 22 while the PCV pipe 19 is held in contact with the protruding portion 22a.

The union nut 23 has a hollow cylindrical shape and is configured to connect the union end 22 to the inlet port 15a. The union nut 23 is formed on its inner peripheral surface with female threads 23b and the inlet port 15a is formed on its outer peripheral surface with male threads 15j, so that the union nut 23 and the inlet port 15a are screw-connected to each other. The union end 22 is further formed on an end portion of the outer peripheral surface with a shoulder portion 22b, which engages a shoulder portion 23a formed in the inner periphery of the union nut 23. The first surface 15c is formed with an annular seal groove 15m to receive an O ring 16 placed between the inlet port 15a and the end face of the union end 22. This O ring 16 may be made of rubber or resin as long as it is elastic.

Similarly, the outlet pipe joint 21 is a union joint and includes a union end 24 and a union nut 25. The union end 24 has a hollow cylindrical shape whose end face is in contact with the second surface 15d. In the inner periphery (a hollow part) of the union end 24, a PCV pipe 20 which is one example of an outlet pipe is disposed. The union end 24 is formed with a protruding portion 24a radially inwardly protruding in an annular flange shape at one end in an axial direction, i.e., at an end of the inner periphery on a side where the union end 24 makes contact with the second surface 15d, so that the PCV pipe 20 makes contact with the protruding portion 24a. Thus, the PCV pipe 20 inserted in the union end 24 is adhered to the union end 24 while the PCV pipe 20 is held in contact with the protruding portion 24a.

The union nut 25 has a hollow cylindrical shape and is configured to connect the union end 24 to the outlet port 15b. The union nut 25 is formed on its inner peripheral surface with female threads 25b and the outlet port 15b is formed on its outer peripheral surface with male threads 15k, so that the union nut 25 and the union end 24 are screw-connected to each other. The union end 24 is further formed on an end portion of the outer peripheral surface with a shoulder portion 24b, which engages a shoulder portion 25a formed in the inner periphery of the union nut 25. The second surface 15d is formed with an annular seal groove 15n to receive an O ring 17 placed between the inlet port 15a and the end face of the union end 24.

(Advantageous Effects of the Pipe Coupling Structure)

Assembling of the pipe section 3 in the present embodiment will be first described below referring to FIG. 4. FIG. 4 is an explanatory diagram showing an assembling manner of the pipe coupling structure 1. The inlet pipe joint 18 and the outlet pipe joint 21 are identical in structure and thus the following explanation is given to only the inlet pipe joint 18 without repeating the same explanation on the outlet pipe joint 21.

As shown in FIG. 4, at the time of factory shipment, the PCV pipe 19 has been adhered to the inner periphery of the union end 22 while the end of the PCV pipe 19 remains in contact with the protruding portion 22a of the union end 22. Specifically, an assembly of the union end 22 having adhered thereto the PCV pipe 19 is delivered from a factory to an actual work site. The union end 22 in this assembled state is disposed in contact with the first surface 15c of the passage block 15 and then secured to the passage block 15 by screwing the union nut 23.

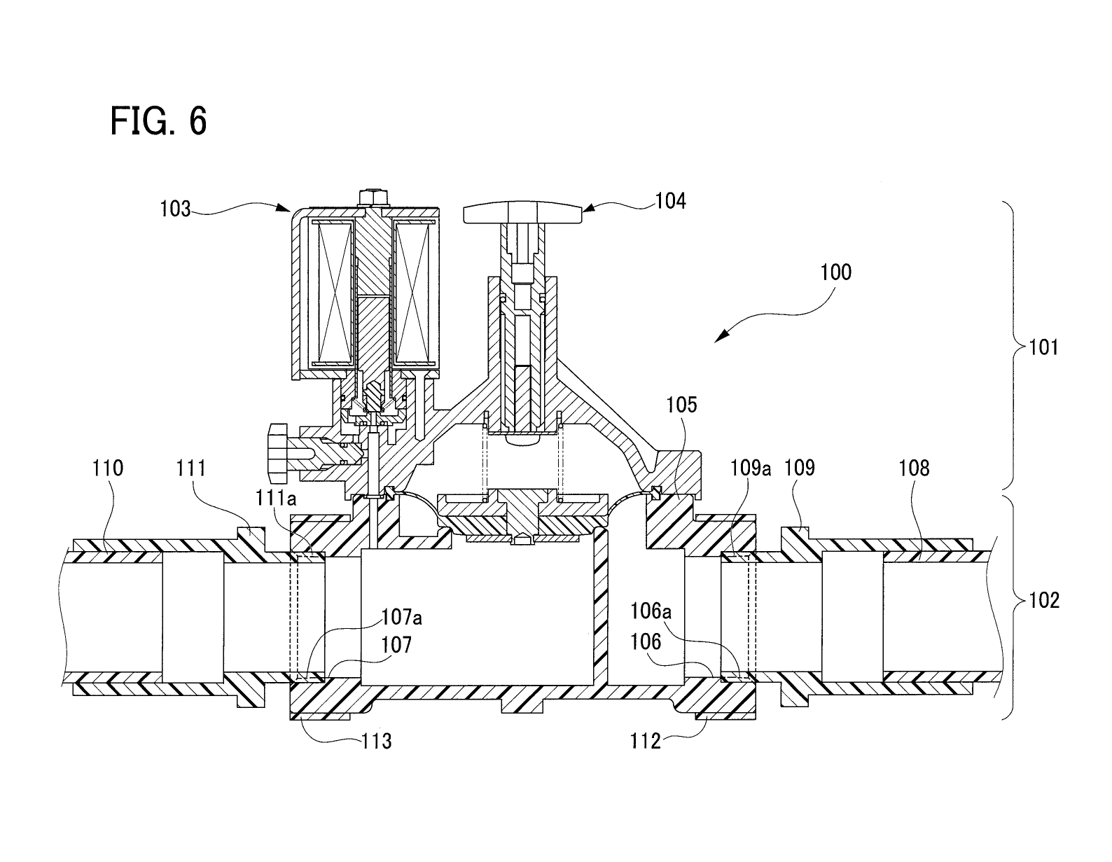

In the conventional art using the passage block 105 made of resin, as shown in FIG. 6, if the taper male threads 109a are screwed too tightly into the taper female threads 106a, the passage block 105 may be broken.

In contrast, different from the conventional art, the union end 22 in the present embodiment does not need to be screwed into the passage block 15. Specifically, it is only necessary to place the union end 22 in contact with the first surface 15c and then tighten the female threads 23b of the union nut 23 onto the male threads 15j of the passage block 15. Thus, the passage block 15 is less likely to be broken. Further, the union nut 23 can be manually tightened by an operator without using any tool. This can facilitate attachment and detachment of the union end 22 and the passage block 15, resulting in easier maintenance. For instance, during a water removal work to prevent freezing of pipes in winter, the union end 22 easy to detach can facilitate the water removal.

In the conventional art using the PCV pipes 108 and 110 being long and hard to handle, if the passage block 105 is screw-connected to the valve sockets 109 and 111 and thereafter the PCV pipes 108 and 110 are adhered to the valve sockets 109 and 111, the PCV pipes 108 and 110 are hard to insert deeply in the valve sockets 109 and 111 as shown in FIG. 6. This causes variation in length between the connected pipes. Thus, their lengths of the pipes have to be adjusted at the actual work site, leading to poor workability.

In the pipe section 3 in the present embodiment, in contrast, the PCV pipe 19 can be adhered to the union end 22 while the PCV pipe 19 is held in contact with the protruding portion 22a at the factory. This PCV pipe 19 is then delivered to an actual work site and assembled with the passage block 15. Accordingly, the PCV pipe 19 and the union end 22 always have a fixed positional relationship, which is less likely to cause variation in length between the connected pipes. This can eliminate the need to adjust the pipe lengths and enhance workability. Moreover, during an assembling work, the three protruding parts 15e extending from the lower surface of the passage block 15 can fixedly support the passage block 15. This allows an operator to conduct any operations with both hands. Thus, workability can be enhanced.

Next, overall operations of the pipe coupling structure 1 will be briefly described below. A first explanation is given to the state in which the inlet port 15a and the outlet port 15b are shut off, that is, they are disconnected from each other. In this state, the electromagnetic valve 4 is in a valve-closed state. As shown in FIG. 1, a fluid communicates, or flows, from the inlet port 15a to the inner passage 15g in the passage block 15. The fluid further flow from the inner passage 15g to the inner passage 31d through a pilot filter not illustrated. The fluid flows from the inner passage 31d to the passage 31b of the body 31 shown in FIG. 2 through a passage not illustrated. The fluid then flows from the passage 31b to the passage 34a through the passage 35c of the valve seat member 35. While the coil 6 of the electromagnetic valve 4 is not energized, the pilot valve element 9 is held in contact with the valve seat 35a by the urging force of the urging spring 11, thereby shutting off communication between the passage 34a and the valve hole 35b.

While the inlet port 15a and the outlet port 15b are shut off from each other, the primary-side pressure in the inlet port 15a is higher than the secondary-side pressure in the outlet port 15b. The urging force of the urging spring 27 is larger than the force generated by the pressure in the outlet port 15b side, thus placing the valve element unit 33 in contact with the valve seat 15f. Therefore, the inlet port 15a and the outlet port 15b are shut off from each other.

The configuration in which the inlet port 15a and the outlet port 15b are communicated with each other will be described below. When the coil 6 is energized, the movable core 8 is attracted by the fixed core 7 located above the movable core 8. Then, the pilot valve element 9 is moved away from the valve seat 35a against the urging force of the urging spring 11, thereby providing communication between the passage 34a and the valve hole 35b. Thus, the valve hole 35b comes into communication with the outlet port 15b through the passages 31c and 15h.

When the inlet port 15a gets communicated with the outlet port 15b, the pressure in the outlet port 15b rises, increasing the force that pushes upward the valve element unit 33. Thus, the valve element unit 33 is pushed upward and moved away from the valve seat 15f against the urging force of the urging spring 27. Accordingly, the inlet port 15a and the outlet port 15b are made to communicate with each other. The valve element unit 33 is moved upward until the fixing part 29 makes contact with the contact portion 26, and therein the valve element unit 33 stops. By rotation of the handle knob 13 to move the rod 14 downward, the valve element unit 33 can be adjusted in position, thereby regulating a flow rate of the fluid.

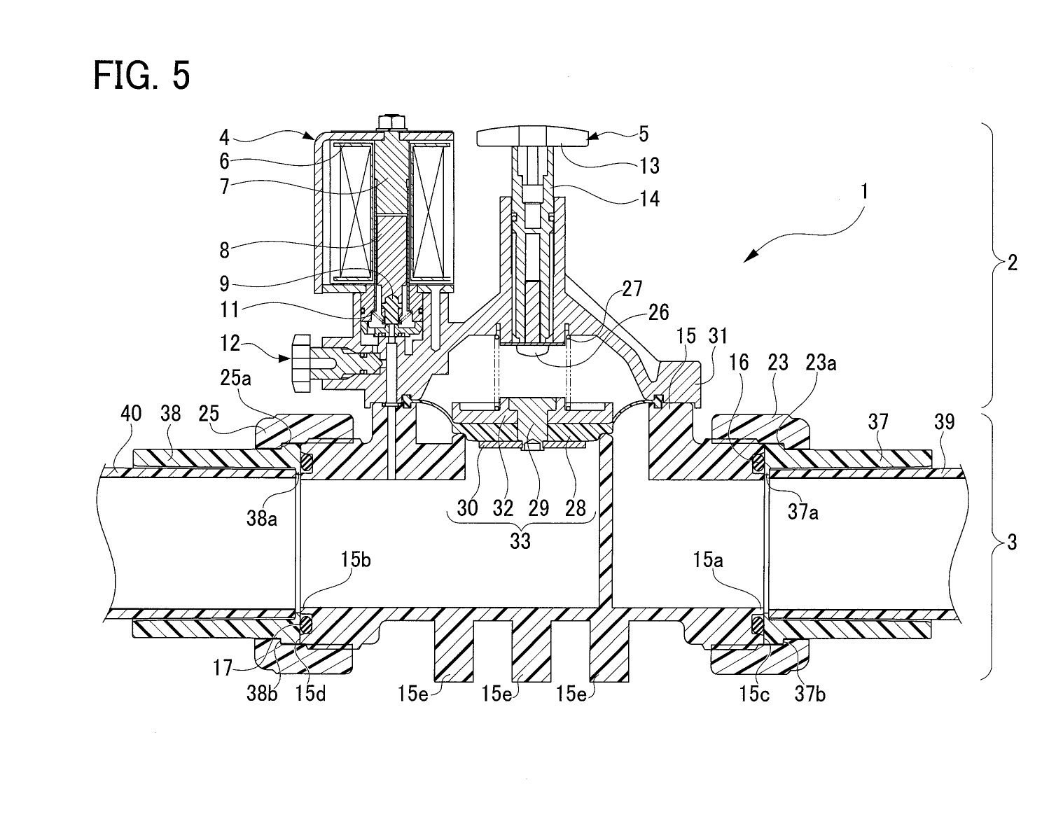

Another example of the pipe coupling structure 1 using PCV pipes 39 and 40 having different diameters from the PCV pipes 19 and 20 shown in FIG. 1 will be explained referring to FIG. 5. For example, whereas the PCV pipes 19 and 20 in FIG. 1 each have a diameter of 40 A (JIS), the PCV pipes 39 and 40 in FIG. 5 each have a diameter of 50 A (JIS). Common or similar parts in FIG. 5 to those in FIG. 1 are given the same reference signs as in FIG. 1 and their details are not repeatedly explained.

Union ends 37 and 38 in FIG. 5 have different inner diameters from the inner diameters of the union ends 22 and 24 in FIG. 1. In the union ends 37 and 38, the PCV pipes 39 and 40 are respectively adhered to the inner periphery of the union ends 37 and 38 while contacting protruding portions 37a and 38a formed radially inwardly protruding in an annular flange shape from an end of the inner periphery of the union ends 37 and 38. The union ends 37 and 38 have outer diameters engageable with the corresponding union nuts 23 and 25. The union ends 37 and 38 are formed, on respective outer periphery, with shoulder portions 37b and 38b which can contact with the shoulder portions 23a and 25a of the union nuts 23 and 25. The aforesaid pipe coupling structure is adaptable to various

PCV pipes having different diameters by simply replacing (selecting) the union end(s) according to the outer diameter of a PCV pipe to be connected to the passage block 15. Accordingly, there is no need to change the diameters of the valve sockets, the inlet port, and the outlet port as in the conventional art. Specifically, it is only necessary to prepare a plurality of union ends having different inner diameters corresponding to the target diameters of the PCV pipes. This can eliminate the need for redundant stocks of passage blocks, union ends, and others, and achieve cost reduction.

As described above, the pipe coupling structure 1 in the present embodiment can provide the following operations and effects.

(1) The pipe coupling structure 1 includes the electromagnetic valve 4 and the passage block 15 having an upper surface on which the electromagnetic valve 4 is mounted and the opposite side surfaces 15c and 15d in which the inlet port 15a and the outlet port 15b are individually formed. The inlet port 15a is connected to the PCV pipe 19 through the inlet pipe joint 18. The outlet port 15b is connected to the PCV pipe 20 through the outlet pipe joint 21. In this pipe coupling structure 1, the inlet pipe joint 18 and the outlet pipe joint 21 are union joints. In the present disclosure, however, at least one of the inlet pipe joint 18 and the outlet pipe joint 21 has only to be a union joint. The union joint 18 (21) includes the union end 22 (24) having a hollow cylindrical shape and being placed in contact with the first surface 15c formed with the inlet port 15a (the second surface 15d formed with the outlet port 15b) and the union nut 23 (25) having a hollow cylindrical shape and connecting the inlet port 15a (the outlet port 15b) with the union end 22 (24). With this configuration, the union ends 22 and 24 are connected to the passage block 15 with the union nuts 23 and 25 while the union ends 22 and 24 are in contact with the first surface 15c or the second surface 15d of the passage block 15. Thus, the inlet pipe joint 18 and the outlet pipe joint 21 do not need to be screwed into the passage block 15 and therefore the passage block 15 is less likely to be broken. Further, the PCV pipes 19 and 20 can be adhered in advance to the union ends 22 and 24 at the time of factory shipment and then connected to the passage block 15. This causes no variation in length between the connected pipes and thus needs no work for adjustment of the pipe length at the actual work site. This leads to enhanced workability.

(2) In the aforesaid pipe coupling structure 1, the PCV pipe 19 (20) is placed in the inner periphery of the union end 22 (24). The union end 22 (24) is formed with the protruding portion 22a (24a) protruding radially inward at the end of the inner periphery on the side where the union end 22 (24) makes contact with the inlet port 15a (the outlet port 15b), so that the protruding portion makes contact with the PCV pipe 19 (20). The PCV pipe 19 (20) is adhered to the union end 22 (24) while the PCV pipe 19 (20) is placed in contact with the protruding portion 22a (24a). Accordingly, the union end 22 (24) can be connected to the passage block 15 by use of the union nut 23 (25) while the union end is in contact with the first surface 15c (the second surface 15d) of the passage block 15. Thus, the inlet pipe joint 18 and the outlet pipe joint 21 do not need to be screwed into the passage block 15. The passage block 15 is therefore less likely to be broken. Further, the union end 22 (24) having adhered thereto the PCV pipe 19 (20) remaining contacted with the protruding portion 22a (24a) can be connected to the passage block 15, so that no variation in length occurs between the connected pipes. This can achieve enhanced workability.

(3) In the aforesaid pipe coupling structure 1, the union end is selected from a plurality of union ends 22, 24, 37, and 38 having different diameters from each other according to the diameter (outer diameter) of the PCV pipe 19, 20, 39, or 40 to be connected. Accordingly, for connection of the PCV pipe 19, 20, 39, or 40 different in outer diameter from a previously used one, the union end 22, 24, 37, or 38 has only to be changed in inner diameter while having the same outer diameter from a previous one (e.g., the union end has only to be replaced with an appropriate union end selected from a plurality of union ends equal in outer diameter but different in inner diameter). Consequently, it is necessary to stock only the union ends having different inner diameters corresponding to different outer diameters of the PCV pipes. This can eliminate the need to stock redundant passage blocks, union ends, and others, and can achieve cost reduction.

(4) In the pipe coupling structure 1 described in one of (1) to (3), the O ring 16 (17) is placed between the first surface 15c (the second surface 15d) and the end face of the union end 22 (24, 37, 38). Since there is no need to apply a seal tape, enhanced workability is achieved. The sealing property by the O ring 16 (17) is also enhanced.

(5) In the pipe coupling structure 1 described in one of (1) to (4), the passage block 15 includes the protruding parts 15e protruding from the lower surface of the passage block 15. Since these protruding parts 15e support the pipe coupling structure 1, pipe arrangement can be facilitated with enhanced workability.

The foregoing embodiments are mere examples and give no limitation to the present invention. The present invention may be embodied in other specific forms without departing from the essential characteristics thereof.

### REFERENCE SINGS LIST

1 Pipe coupling structure
4 Electromagnetic valve
15 Passage block
15a Inlet port
15b Outlet port
15c First surface
15d Second surface
15e Protruding part
16, 17 O ring
18 Inlet pipe joint
19, 20 PCV pipe
21 Outlet pipe joint
22, 24 Union end
22a, 24a Protruding portion
23, 25 Union nut

What is claimed is:

1. A pipe coupling structure comprising: an electromagnetic valve and a passage block having an upper surface on which the electromagnetic valve is mounted and opposite side surfaces in which an inlet port and an outlet port are individually formed, the inlet port being connected to an inlet pipe through an inlet pipe joint and the outlet port being connected to an outlet pipe through an outlet pipe joint,
wherein at least one of the inlet pipe joint and the outlet pipe joint is a union joint,
the opposite side surfaces are a first surface and a second surface, the first surface being formed with the inlet port and the second surface being formed with the outlet port, and
the union joint includes:
a union end having a hollow cylindrical shape and being in contact with one of the first surface and the second surface; and
a union nut having a hollow cylindrical shape and being configured to connect one of the inlet port and the outlet port with the union end.

2. The pipe coupling structure according to claim 1, wherein
at least one of the inlet pipe and the outlet pipe is placed in an inner periphery of the union end, and
the union end is formed with a protruding portion protruding radially inward at an end of the inner periphery on a side where the union end makes contact with one of the first surface and the second surface, the protruding portion making contact with the at least one of the inlet pipe and the outlet pipe, and the at least one of the inlet pipe and the outlet pipe is adhered to the union end while the at least one of the inlet pipe and the outlet pipe is placed in contact with the protruding portion.

3. The pipe coupling structure according to claim 2, wherein the union end is selected from a plurality of union ends having different inner diameters from each other according to an outer diameter of the at least one of the inlet pipe and the outlet pipe to be connected to the passage block.

4. The pipe coupling structure according to claim 1, further comprising an elastic member placed between one of the first surface and the second surface and an end face of the union end.

5. The pipe coupling structure according to claim 1, wherein the passage block includes a protruding part protruding from a lower surface of the passage block.

6. The pipe coupling structure according to claim 2, further comprising an elastic member placed between one of the first surface and the second surface and an end face of the union end.

7. The pipe coupling structure according to claim 3, further comprising an elastic member placed between one of the first surface and the second surface and an end face of the union end.

8. The pipe coupling structure according to claim 2, wherein the passage block includes a protruding part protruding from a lower surface of the passage block.

9. The pipe coupling structure according to claim 3, wherein the passage block includes a protruding part protruding from a lower surface of the passage block.

10. The pipe coupling structure according to claim 4, wherein the passage block includes a protruding part protruding from a lower surface of the passage block.

11. The pipe coupling structure according to claim 6, wherein the passage block includes a protruding part protruding from a lower surface of the passage block.

12. The pipe coupling structure according to claim 7, the passage block includes a protruding part protruding from a lower surface of the passage block.
